(19) United States
(12) Patent Application Publication
(10) Pub. No.: US 2012/0204639 A1
(43) Pub. Date: Aug. 16, 2012

(54) Magnetic rotation sensor

(76) Inventor: Chris Mogridge, Oxford, MS (US)

(21) Appl. No.: 13/385,325

(22) Filed: Feb. 14, 2012

Related U.S. Application Data
(60) Provisional application No. 61/463,368, filed on Feb. 15, 2011.

(51) Int. Cl. G01P 3/44; B60B 21/06

(52) U.S. Cl. 73/504.01; 301/59

(57) ABSTRACT

The present invention teaches a novel apparatus and method for providing the magnetic impulse required to drive an electronic pickup used to indicate the speed of a bicycle. In a conventional spoked wheel, one of the spokes is fabricated from a magnetic material such that each time that particular spoke passes the pickup the requisite current impulse is transmitted to the handlebar mounted receiving unit.

This non-provisional application for utility patent claims the benefit of U. S. provisional application 61/463,368 within the meaning of 35 USC 119(a), filed Feb. 15, 2011.

### BRIEF DESCRIPTION

The subject of this invention relates generally to the wheel industry and more particularly to bicycle wheels. More specifically, the disclosed invention integrates the magnetic impulse apparatus used to sense wheel speed into the wheel itself, thereby eliminating the need for a separate magnet. The invention is suitable for all types of wheels including spoke type and disk type wheels and no matter what the wheel material is constructed of. This is accomplished by the use of a series of instantiations using several different magnetic impulse materials.

### BACKGROUND OF THE INVENTION

Bicycles have been in use for hundreds of years. And while the form, and indeed the function of the bicycle has shifted over time, one constant remains: a bicycle requires one or more wheels to work. Note that throughout this specification the term “bicycle” will be used, however it will be recognized by those of skill in the art that this term is intended to be generic and is meant to include unicycles, tricycles, quadricycles and other forms of wheeled, human powered vehicles such as recumbent cycles, wheelchairs, baby stroller joggers and child carts attached to bicycles.

One important data point that bicycle riders have been concerned with over time is speed; how fast the bicycle is moving. Certainly this pertains to competitive cyclists, but it is also important to delivery riders, commuters, recreational riders and so on. The speed of the bicycle determines the time required to transit a specific distance thus has import to numerous categories of cyclists.

There exists a plethora of devices and methods available to provide this speed data. In the early days of the consumer bicycle, the speed was measured through the use of a cable driven speedometer in the same way as early automobile speeds were measured. This method remains in use today and involves a gear driven sending unit attached to a rotating magnet inside a housing mounted in easy view of the cyclist. As the cable turns faster in response to increasing speed, the internal magnet causes the indication needle in the housing to display greater speed.

A second, more common method in use modernly is the result of the advance of semiconductor electronics. A receiving unit, either hard wired or wireless, is mounted on the handlebar of the bicycle in easy view of the cyclist. A magnetic pickup unit is mounted either on the front fork or chain stay in a fixed position. A small magnet is attached to the wheel, usually to a spoke, and as the wheel turns the magnet follows, passing in front of the pickup once every revolution. The magnetic impulse is converted to an electrical current that then is operated upon by the receiving unit which subsequently drives a display to inform the cyclist of the current speed. This method is far more accurate and less sensitive to exposure to the elements thus tends to make up the majority of the units in use.

A third method in use contemporarily, and one that is becoming more and more practical due to mass production effects is the GPS [Global Positioning Satellite] based cycling computer. In this method a multifunctional device is placed within easy view of the cyclist containing a GPS receiver and supporting electronics. As the cyclist moves along a course the updated positional data is used to calculate speed over the surface and then indicated on a display in the same manner as the magnetic sensor above.

While these methods are functional, each suffers from numerous drawbacks. The mechanical cable system has serious accuracy problems and is very badly affected by exposure to the elements, for example mud, sand and water. Any contaminant fouling the drive mechanism will cause a decrease in accuracy at the indicator and often results in damage to the drive gear mechanism. The modern magnetic pickup devices suffer from loss of accuracy due to changes in the magnet/pickup separation distance and area coverage caused by vibration and wheel differences and also suffer from potential damage to the spoke and/or sensor due to physical displacement caused by impacts from foreign material. The GPS devices, while mitigating most of the disadvantages with the other methods are still relatively expensive compared to either wired or wireless indicating devices and suffer from delayed speed indication due to processing time and satellite signal issues.

But the major drawback of both of the cable and wired/wireless prior art methods is wheel interchangeability. Since in both cases the sending units are triggered by some physical part on the wheel, if the wheel is changed the required part is missing, thus the speed indication is lost. This is critical for competitive cyclists, but affects all types of cyclists just the same. In order to overcome this inherent disadvantage, a spare wheel of exactly the same characteristics as the wheel being replaced must be at hand, otherwise the time must be taken to transfer the physical part from one wheel to another. And while the GPS method resolves this particular disadvantage, the expense of this method can be prohibitive for all but the most elite cyclists.

What would be desirable is a magnetic speed sensing apparatus that is integrated into the wheel itself such that there are no separate physical parts to contend with, no possible deterioration of performance resulting from exposure to the elements, and no possibility that the positional reference between the pickup and the driving magnetic element will shift due to vibration, wheel alignment or impacts from foreign material. What would be further desirable would be such a speed sensing apparatus that is cost effective, making it available to the broadest possible cycling population.

### SUMMARY OF THE INVENTION

The present invention teaches a novel apparatus and method for providing the magnetic impulse required to drive an electronic pickup used to indicate the speed of a bicycle. In a conventional spoked wheel, one of the spokes is fabricated from a magnetic material such that each time that particular spoke passes the pickup the requisite current impulse is transmitted to the handlebar mounted receiving unit.

In the preferred embodiment the apparatus is associated with a classical spoked wheel. The number of spokes is irrelevant and the configuration of the spokes, i.e. radial or cross-laced, is also irrelevant. The apparatus of the present invention may be successfully used with any diameter wheel and on any type of bicycle, for example, mountain bike, road bike, recumbent bike and so on.

In an alternate embodiment the apparatus is associated with a so called disk wheel. That is a wheel that has a solid center rather than classical spokes. To accomplish this, a single spoke fabricated from the same magnetic material as above is affixed to the surface of the disk wheel. Thus on every revolution the single spoke passes the pickup and the system performs in an identical way.

In yet another embodiment, the apparatus is associated with so called tri-spoke wheels. These wheels are special purpose aerodynamic wheels typically used for a special skill known as time trialing. To accommodate this type of wheel a single spoke fabricated from the same magnetic material as above is affixed to one of the carbon fiber spokes. Thus on every revolution the single spoke passes the pickup and the system performs in an identical way.

The present invention overcomes the disadvantages of the prior art since it is not affected by exposure to the elements, the dimensional reference between the magnetic spoke and the pickup is not affected by vibration or wheel alignment and the magnetic spoke travels with the wheel so no physical part need be removed and reinstalled. As well as the advantages discussed above, other advantages of the present invention are discussed below in conjunction with the drawings and figures attached.

### BRIEF DESCRIPTION OF THE DRAWINGS

FIG. 1: is a view of a typical prior art apparatus.

FIG. 2: is a view showing the disposition of the apparatus of the present invention on a typical bicycle front wheel.

FIG. 3: is a detailed view of the apparatus of the present invention installed on a typical bicycle wheel.

FIG. 4: is a detailed view of a disk wheel embodiment of the present invention.

FIG. 5: is a detailed view of a tri-spoke wheel embodiment of the present invention.

### DETAILED DESCRIPTION OF PREFERRED EMBODIMENTS

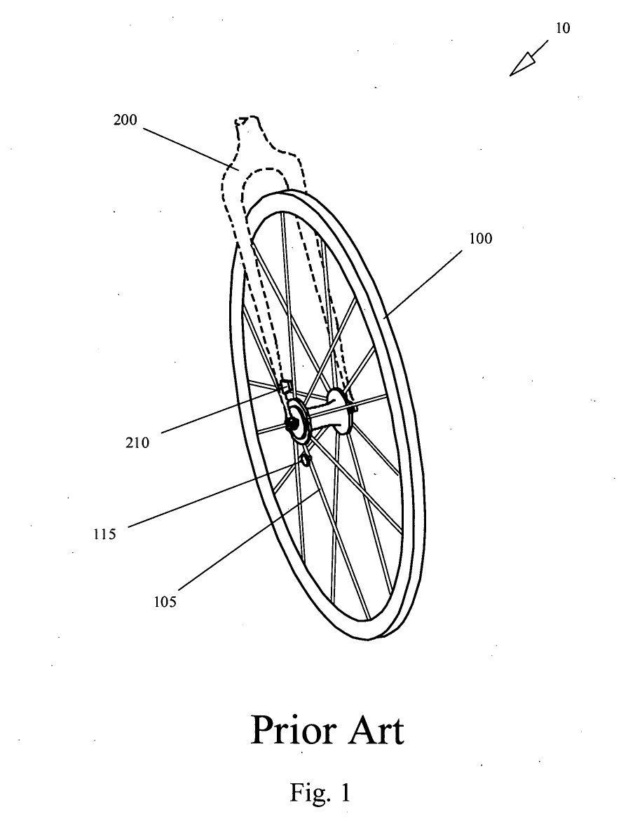

As described briefly above, the apparatus of the present invention improves on the prior art by eliminating all the disadvantages while providing superior performance. To more accurately understand the reasons for this FIG. 1 presents a typical spoked bicycle wheel 10 equipped with a conventional electronic pickup. In normal use the wheel 100 is attached to the bicycle using some sort of fastening means not shown. Since the exact fastening means has no bearing on the invention or the method of its use it has been deleted for simplicity. Note also that the wheel is shown without a tire, but as will be understood by those of skill in the art, the presence or absence of a tire in the drawing has no impact on the efficacy or operation of the invention. Also note that while the wheel depicted is typical of a so called road bike, the invention disclosed may be used on virtually any wheel on a bicycle, thus the scope of the present invention is limited only by the claims.

The wheel 100 is mounted to the front fork 200 [shown in dashed lines for reference only], which is in turn attached to a bicycle frame. A conventional pickup 210 is affixed to the lower portion of the fork 200. Separate magnet 115 is attached to one of a plurality of spokes 105, usually by means of a set screw. Pickup 210 and magnet 115 may be from a plurality of providers, but by way of example, the pair shown represents a model Edge 500 and are provided by Garmin International, Inc., Olathe, Kans. Each time the magnet 115 passes the pickup 210 a current pulse is generated. This pulse is transmitted to the receiver on the handlebars [not shown] where it is converted into speed information.

As can be seen, this method suffers from the serious problem of reference dimension to the pickup. If the set screw, or any other method of mounting the separate magnet fails, the distance horizontally, vertically and/or rotationally will change, causing the produced current pulse to be insufficient to properly drive the receiver. Typically this dimension is critical thus prone to failure. Worse, due to the small separation distance required, typically less than one tenth of an inch, any rotational slippage will result in physical contact between the magnet and the pickup which can destroy one of both.

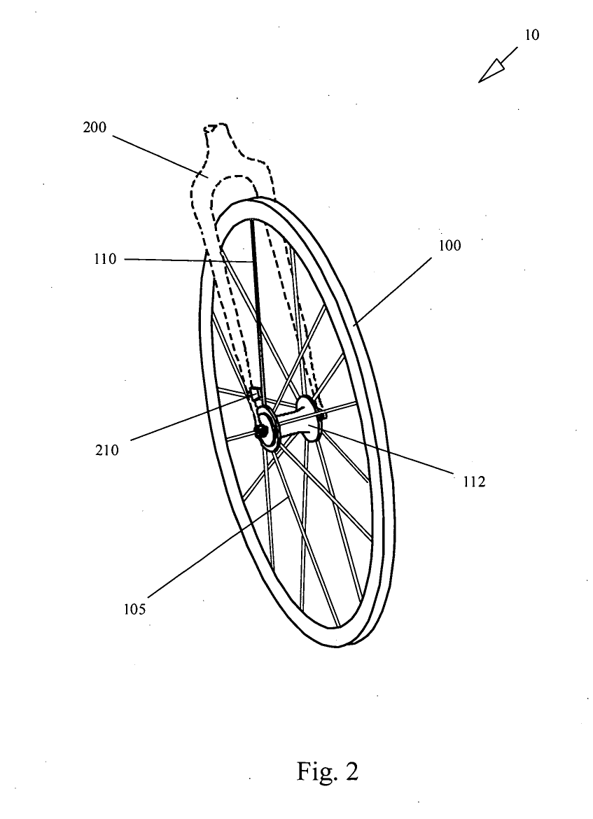

FIG. 2 presents the same wheel 10 but in this instance the wheel 100 is constructed using the apparatus of the present invention. Again, front fork 200 has pickup 210 affixed on the lower portion. Also as with the above, a plurality of spokes 105 are used in the construction of the wheel 100. Note that although a radially spoked wheel is shown, a cross-laced classic wheel, a tri-spoke wheel or some other type of wheel could be used, thus the radially spoked wheel is exemplary only and should not be read as a limitation on the scope of the invention.

In this particular wheel the apparatus of the present invention is shown as magnetized spoke 110. Magnetized spoke 110 is the same in all characteristics as the balance of the spokes 105 except that spoke 110 is fabricated from a magnetic material. In a first embodiment, magnetized spoke 110 is made from type 430 stainless steel alloy and is magnetized by a conventional magnetizing process. Alternatively, various coatings may be applied over non-ferrous materials to achieve the same result. For example, a neodymium/iron/boron [NdFeB] coating such as that provided by Alliance LLC, Valparaiso, Ind. over a carbon fiber or aluminum spoke may be used in order to maintain wheel balance and consistency of construction.

Each time magnetic spoke 110 passes the pickup 210 the appropriate current pulse is generated and transmitted to the receiver. Since the dimensions between the pickup 210 and the magnetic spoke 110 are fixed due to the integrated nature of the magnetized spoke 110 in the wheel 100, there can no shift in the relative positions of the parts. This is a significant improvement over the prior art. Moreover, because the magnetic spoke 110 runs from the wheel hub 112 to the wheel rim 100, the pickup 210 may be placed with substantially less restriction than with contemporary pickup placement.

Since the apparatus of the present invention is comprised of a magnetic spoke 110, it will not be affected by the elements. The lines of flux about the magnetic spoke 110 are constant and will impart the same energy to the pickup 210 regardless of whether there is intervening water or dirt. This feature of the present invention is a significant improvement over the prior art. Additionally, contemporary screw-mounted magnets tend to collect mud and other foreign matter which increases the likelihood that there will be damaging physical contact between the magnet and the pickup.

Suppose now that the wheel 100 must be removed, for example, to repair a puncture. Since the dimensions between the pickup 210 and the magnetized spoke 110 are fixed due to the integrated nature of the magnetized spoke 110 in the wheel 100, there will be no deleterious effects of removal and replacement. Since the distance between the magnetized spoke 110 and the pickup 210 is referenced by the mounting on the wheel 100 in the fork 200, once the wheel is replaced the distance will, by virtue of the fastening mechanism, be the same as when the wheel was removed. This feature of the present invention is a significant improvement over the prior art.

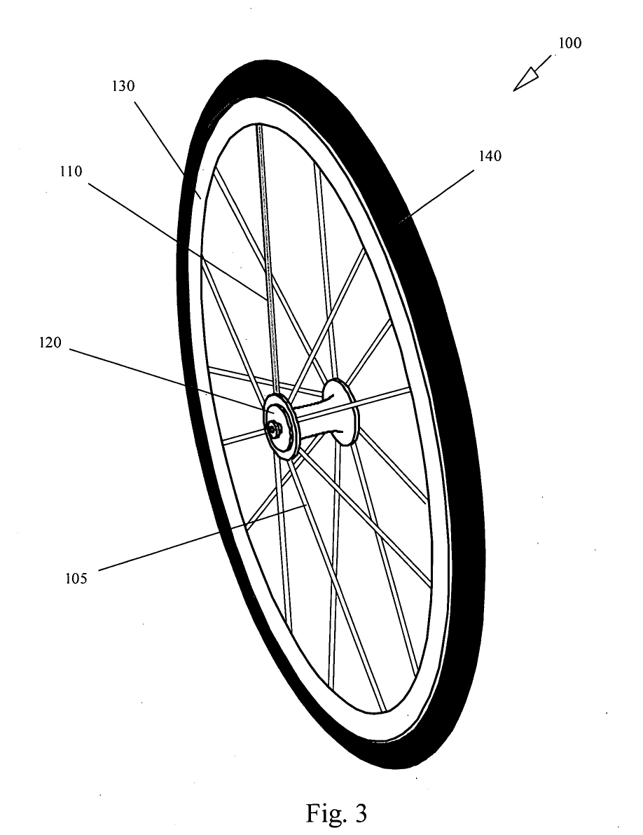

As was mentioned above, the present invention may be used with a variety of wheel types. FIG. 3 discloses a first embodiment 100 of the present invention. In this embodiment a typical radially spoked wheel using aluminum blade type spokes is shown. Wheel rim 130 has a tire 140 mounted to it in the contemporary manner. Since the exact manner of mounting the tire does not impinge on the operation of the invention it is shown for reference only. A plurality of flat radially disposed aluminum spokes 105 are attached between wheel hub 120 and wheel rim 130. One of the plurality of flat aluminum spokes 110 has been subjected to a process, such as that described above, that has placed a magnetic coating about the entire length of the spoke. Note that in this embodiment the coating has been applied along the entire length of the spoke; however, it will be recognized by those of skill in the art that the coating could be applied to only a specific part of the spoke, for example, that part of the spoke closest to the wheel hub, and not depart from the spirit of the invention. Further, the exact type of magnetic coating may vary without departing from the principles of the invention, thus the type described is exemplary only.

While numerous types of coatings may be used to create a magnetic spoke out of a non-magnetic material, certain stainless steel alloys may be used as well. For example, type 430 stainless alloy has the anti-corrosion properties desired in a bicycle wheel, yet possesses a tensile strength on the order of 75,000 psi, making it an ideal candidate for wheel spokes. Type 430 stainless alloy has an 87% iron content which is why it is more suited to magnetizing. Stainless alloys such as 301 and 302 have an iron content of 75% and 70% respectively, so are less useful as a magnetized spoke.

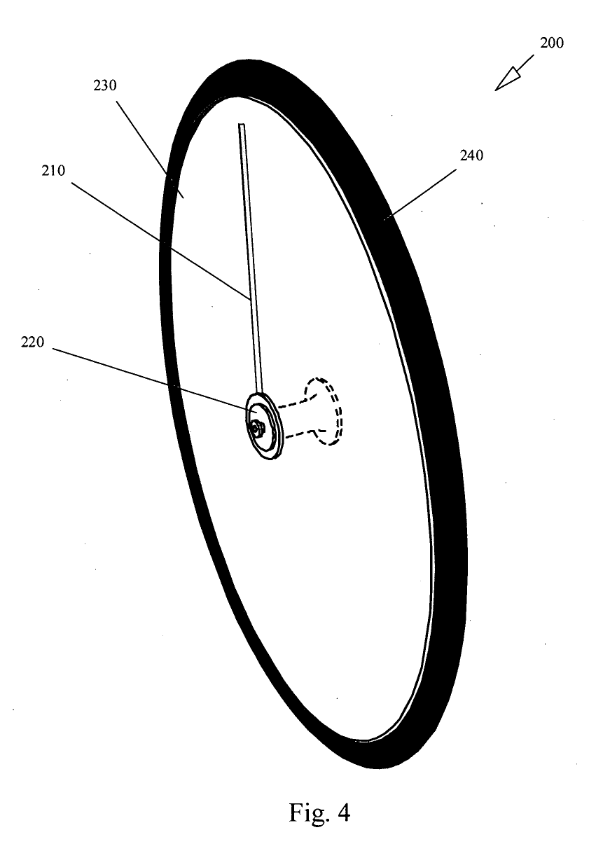

Referring now to FIG. 4, a disk type bicycle wheel 200, such as that favored by riders engaged in the time trial type of race is shown. With this type of wheel, the tire 240 is mounted on a solid disk that forms the rim 230 and provides the physical mounting for the hub 220. Since the rim is solid, there are no conventional spokes to magnetize, thus an alternative method of providing the magnetic impulse is required. In this embodiment, a thin strip of aluminum 210 has been coated with a magnetic coating as described above. The magnetized aluminum strip 210 is glued to the surface and oriented to emulate a spoke, thus each time the aluminum magnetic strip passes the pickup it generates the requisite pulse in the same manner as a conventional spoke.

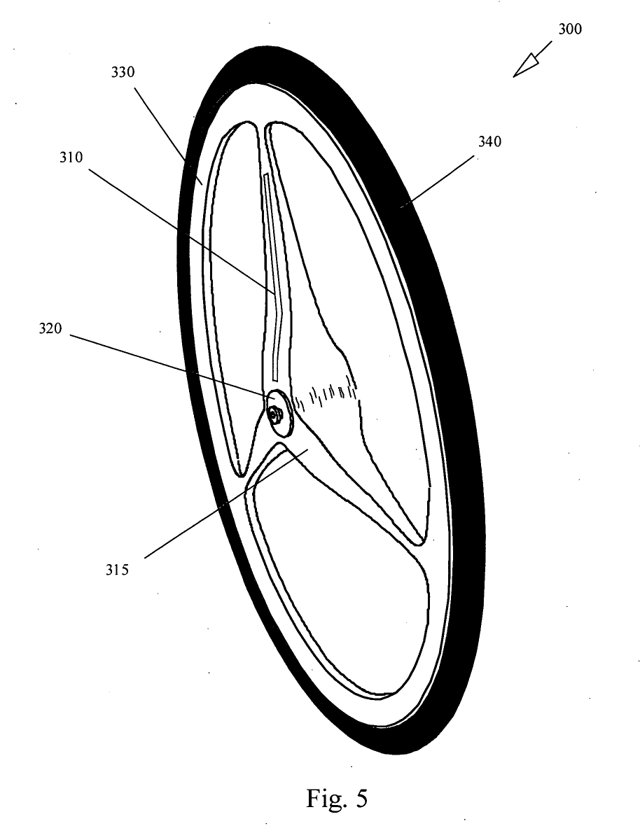

FIG. 5 presents a third embodiment of the present invention. In this embodiment a tri-spoke wheel 300 is shown. The tri-spoke wheel is favored by triathletes and is usually made from carbon fiber and the spokes and rim 330 are formed as a single piece. As with the disk wheel described just above, the tri-spoke wheel has a tire 340 mounted on the outside of the rim and a hub 320 located at the center. Since the carbon fiber spokes 315 are non-magnetic, the same type of solution used for the disk wheel may be employed for the tri-spoke wheel. Since the thin aluminum strip 310 can be easily formed, it may be made to conform to the spoke 315 and then glued in place. Alternatively, the strip may be molded into the wheel spoke as part of the fabrication process.

Each of the wheel types discussed in detail above present specific implementations of the present invention. It will be understood by those of skill in the art that the same principles can be applied to wheels of all types and still not depart from the scope of the invention. By way of example, but not meant as a limitation, the principles of the present invention could be applied to wheel chairs, recumbent bicycles, or any other type of wheel used by a human powered vehicle. The apparatus of the present invention is also suitable for certain push type vehicles, for example, a baby stroller used by joggers.

The integration of the magnetized element into the wheel itself yields an improved method of operation. In use, the magnetized spoke, or alternatively a thin strip of magnetized material, passes the externally mounted sensor once on each revolution of the wheel. In so doing, a magnetic impulse is induced and subsequently is converted to an electrical current that then is operated upon by the receiving unit which drives a display to inform the cyclist of the current speed.

One advantage of the present is that it does not require a separate magnet attached to a spoke of the wheel. This means that there is one less part to fail and that the manufacturing process is simpler. Moreover, there is no danger that the magnetic spoke will ever come in contact with the pickup as might happen with a separate magnet.

A second advantage of the present invention is that it is unaffected by the elements. Thus if water, mud, sand or dirt accumulates on the bicycle frame in proximity to the pickup, no loss of signal strength will occur. Further, there is significantly less likelihood that a buildup of foreign material will occur which, with the conventional separate magnet method, could cause damage and presents a safety hazard to the rider.

A third advantage is that the pickup unit is less affected by vertical location due to the fact that the entire length of the spoke is magnetized. As a bicycle transits the surface, vibrations from the road or trail are transmitted to the various components, including the spokes of a wheel. These vibrations can cause a vertical misalignment of a conventional separate magnet which has an adverse effect on performance of the speed sensing system.

A fourth advantage is maintenance. Since the magnetic element stretches from the hub to the outer diameter of the rim there will be no change in dimension from removal and replacement. This is because the physical location of the wheel with respect to the bicycle frame is set by the hub. Since the spoke and wheel are fixed together, no possible misalignment can occur. Additionally, there is no possibility that damage can occur to the pickup due to contact between the separate magnet of the conventional method and the pickup.

A fifth advantage of the present invention is that it may be used with a very broad variety of wheels. This includes the conventional spoked wheel, the solid core disc wheel and the tri-spoked type wheel. Further, the apparatus of the present invention may be used on the majority of human powered vehicles including bicycles, recumbent cycles, wheelchairs and baby stroller joggers.

A sixth advantage of the present invention is that it may be manufactured from a broad spectrum of materials, for example aluminum, steel or carbon fiber. The only limitation is the ability of the material used to accept a magnetic coating. The result is that manufacturers of all types of wheels can adapt the apparatus to their particular needs.

What is claimed is:

1. An improved magnetic rotational speed sensing apparatus, the improvement comprised of:
a wheel;
a magnetized element, said magnetized element being an integral part of said wheel, and;
a sensor, said sensor mounted separately from said wheel and in such proximity to said magnetized element such that when said wheel rotates on its axis said magnetized element passes said sensor generating a series of magnetic impulses, said series of magnetic impulses being indicative of the speed of said wheel.

2. The wheel of claim 1 further comprised of:
a rim, said rim having disposed about its outer circumference a series of holes for receiving a first end of a series of spokes;
a hub, said hub having an axel about which said rim rotates, said hub also having a series of holes disposed about either side, said holes used to receive the opposite end of said spokes, and;
said series of spokes radially connected between said hub and said rim, one of said series of spokes having been magnetized to a field strength necessary to trigger a magnetic pulse in a sensor mounted external to said rim, said hub and said series of spokes.

3. The wheel of claim 1 further comprised of:
a rim;
a hub, said hub having an axel about which said rim rotates, and;
said rim and said hub being connected by a solid material such that said solid material, said hub and said rim form a disc, and;
said solid material having a thin strip fixably disposed radially between said hub and said rim, said thin strip having been magnetized to a field strength necessary to trigger a magnetic pulse in a sensor mounted external to said rim, said hub and said solid material.

4. The wheel of claim 1 further comprised of:
a rim;
a hub, said hub having an axel about which said rim rotates, and;
three spokes wherein said rim, said hub and said three spokes are all formed from a single material, one of said three spokes having a thin strip fixably disposed radially between said hub and said rim, said thin strip having been magnetized to a field strength necessary to trigger a magnetic pulse in a sensor mounted external to said rim, said hub and said three spokes.

5. The wheel of claim 1 wherein said wheel is suitable for use on a bicycle.

6. The wheel of claim 1 wherein said wheel is suitable for use on a wheelchair.

7. The wheel of claim 1 wherein said wheel is suitable for use on a baby stroller.

8. The wheel of claim 2 wherein one of the spokes is made from aluminum that has had applied to its entire length a magnetic coating of sufficient field strength to trigger a magnetic impulse in a sensor.

9. The wheel of claim 2 wherein one of the spokes is made from type 430 stainless steel alloy that has been magnetized to sufficient field strength to trigger a magnetic impulse in an external sensor.

10. The wheel of claim 3 wherein the thin strip is made from aluminum that has had applied to its entire length a magnetic coating of sufficient field strength to trigger a magnetic impulse in an external sensor.

11. The wheel of claim 4 wherein the thin strip is made from aluminum that has had applied to its entire length a magnetic coating of sufficient field strength to trigger a magnetic impulse in an external sensor.

12. An improved method for sensing the speed of a spoked wheel comprised of:
replacing a non-magnetized spoke with a magnetized spoke in a series of spokes of a spoked wheel;
placing an external sensor in proximity to said spoked wheel such that each time said magnetized spoke passes by said external sensor a magnetic pulse is generated, and;
counting said magnetic pulses to determine the speed of said wheel.

13. An improved method for sensing the speed of a disc wheel comprised of;
attaching a thin strip to the solid material forming the wheel, said thin strip disposed radially and having had applied to its entire length a magnetic coating of sufficient field strength to trigger a magnetic impulse in an external sensor;
placing an external sensor in proximity to said solid material forming said wheel such that each time said thin strip passes by said external sensor a magnetic pulse is generated, and;
counting said magnetic pulses to determine the speed of said wheel.
